(19) United States
(12) Patent Application Publication
(10) Pub. No.: US 2025/0087781 A1
(43) Pub. Date: Mar. 13, 2025

(54) WIRELESS THERMAL CONTROL FOR A BATTERY CELL

(71) Applicant: Caterpillar Inc., Peoria, IL (US)

(72) Inventors: Jinhui SUN, Dunlap, IL (US); Peitong JIN, Dunlap, IL (US)

(73) Assignee: Caterpillar Inc., Peoria, IL (US)

(21) Appl. No.: 18/465,061

(22) Filed: Sep. 11, 2023

(51) Int. Cl. H01M 10/637; H01M 10/48; H01M 10/615; H01M 10/6571

(52) U.S. Cl. CPC H01M 10/637; H01M 10/486; H01M 10/615; H01M 10/6571; H01M 10/647; H01M 2200/106

(57) ABSTRACT

A battery module may include a battery cell, and a thermal management device, mounted on the battery cell. The thermal management device may include a heating element contacting the battery cell and configured to transfer heat to the battery cell, and a temperature sensor configured to collect temperature data relating to the battery cell. The battery module may include a controller configured to wirelessly control the heating element based on the temperature data.

### TECHNICAL FIELD

The present disclosure relates generally to batteries and, for example, to wireless thermal control for a battery cell.

### BACKGROUND

A machine may include one or more battery packs to provide power to components of the machine, such as lights, computer systems, and/or a motor, among other examples. A battery pack may be associated with a modular design that includes multiple battery modules. A battery module may include multiple battery cells. A discharging capability and/or a charging capability of a battery cell may diminish in cold ambient temperatures. For example, in temperatures below 0° Celsius, a battery cell may lack a charging capability. Accordingly, a performance of a machine that uses a battery pack may be impaired in cold ambient temperatures.

China Patent No. 107611522 (the '522 patent) discloses a battery heating control method for a battery management system of an electric vehicle that addresses charging and discharging a battery pack at low temperature. However, the '522 patent does not indicate a placement for a heating element on a battery cell to facilitate efficient and uniform heating of the battery cell. Moreover, the '522 patent does not describe using wireless control of a heating element on a battery cell to reduce wiring and associated hardware that increases a weight, a footprint, and a complexity of a battery module, and is subject to electrical shorts, wire abrasion, and/or cable disconnection (e.g., due to vibration), among other examples.

The thermal management device of the present disclosure solves one or more of the problems set forth above and/or other problems in the art.

### SUMMARY

A battery assembly may include a battery cell including a casing having a first end and a second end opposite the first end, and a terminal connected at the first end of the casing. The battery assembly may include a thermal management device including a heating element contacting the first end of the casing and configured to transfer heat to the battery cell. The thermal management device may include a temperature sensor configured to collect temperature data relating to the battery cell. The thermal management device may include a wireless communication component configured to wirelessly receive control commands, based on the temperature data, for the heating element. The thermal management device may be configured to control the heating element in accordance with the control commands.

A battery module may include a battery cell, and a thermal management device mounted on the battery cell. The thermal management device may include a heating element contacting the battery cell and configured to transfer heat to the battery cell. The thermal management device may include a temperature sensor configured to collect temperature data relating to the battery cell. The battery module may include a controller configured to wirelessly control the heating element based on the temperature data.

A thermal management device may include a heating element configured to transfer heat to a battery cell. The thermal management device may include a temperature sensor configured to collect temperature data relating to the battery cell. The thermal management device may include a wireless communication component configured to wirelessly receive control commands, that are based on the temperature data, for the heating element.

### BRIEF DESCRIPTION OF THE DRAWINGS

FIG. 1 is a diagram of an example battery pack.

FIG. 2 is a diagram of an example battery module.

FIG. 3 is a diagram of an example battery assembly.

### DETAILED DESCRIPTION

This disclosure relates to a battery assembly, battery module, and/or battery pack, and is applicable to any machine application that uses power provided by a battery. For example, the machine may perform an operation associated with an industry, such as mining, construction, farming, transportation, or any other industry. For example, the machine may be an electric or hybrid vehicle, or an electric or hybrid work machine (e.g., a compactor machine, a paving machine, a cold planer, a grading machine, a backhoe loader, a wheel loader, a harvester, an excavator, a motor grader, a skid steer loader, a tractor, and/or a dozer), among other examples. Additionally, or alternatively, the battery assembly, battery module, and/or battery pack described herein may be used in an energy storage application, such as for solar energy storage and/or wind energy storage, among other examples. As used herein, “battery cell,” “battery,” and “cell” may be used interchangeably.

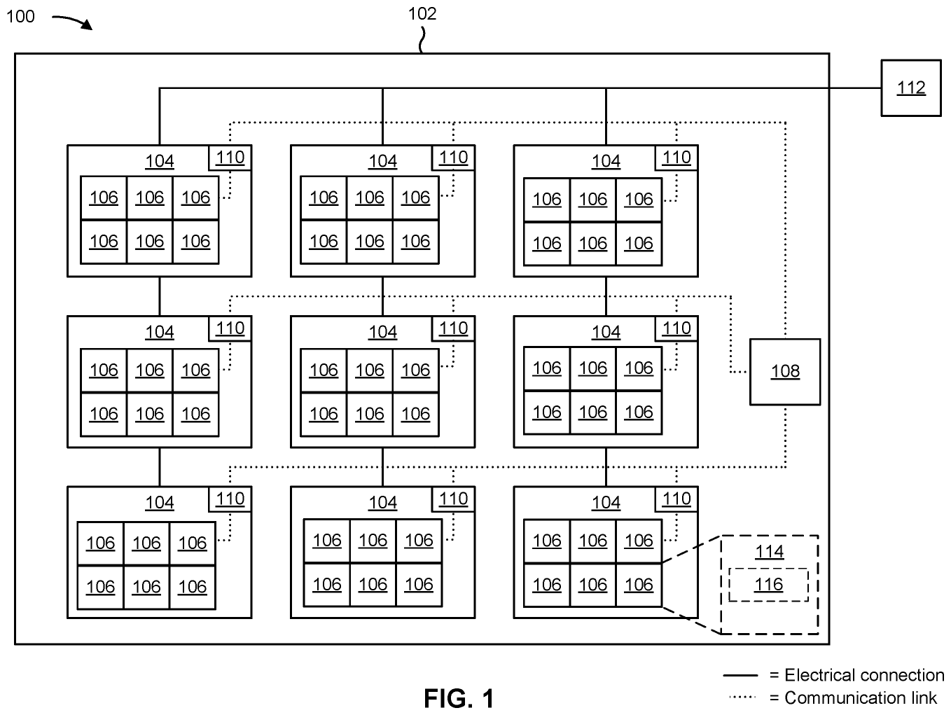

FIG. 1 is a diagram of an example battery pack 100. The battery pack 100 may include a battery pack housing 102, one or more battery modules 104, and one or more battery assemblies 106. The battery pack 100 includes a battery pack controller 108 associated with storing information and/or controlling one or more operations associated with the battery pack 100. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as a computing system or an electric motor, among other examples. As another example, the component 112 may provide energy to the battery pack 100 (e.g., to be stored by the battery assemblies 106). In such examples, the component 112 may be a power generator, a solar energy system, and/or a wind energy system, among other examples.

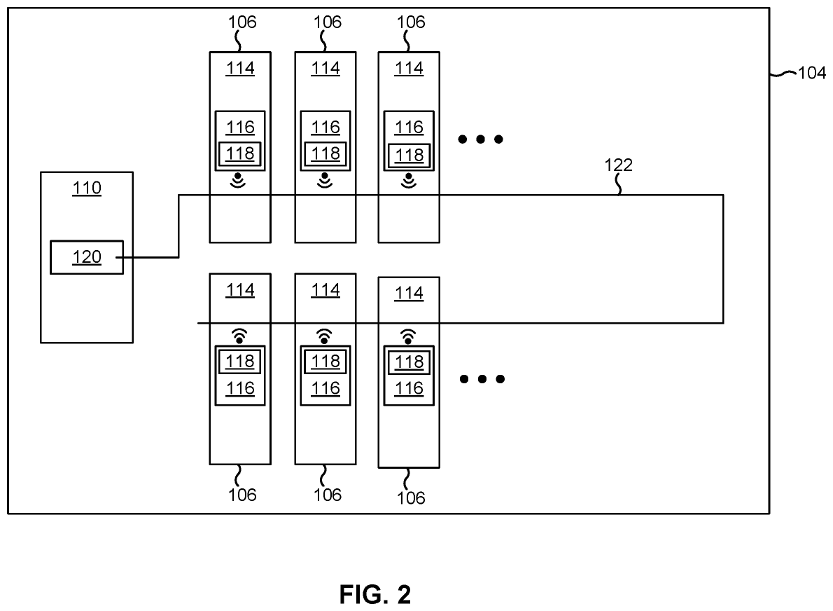

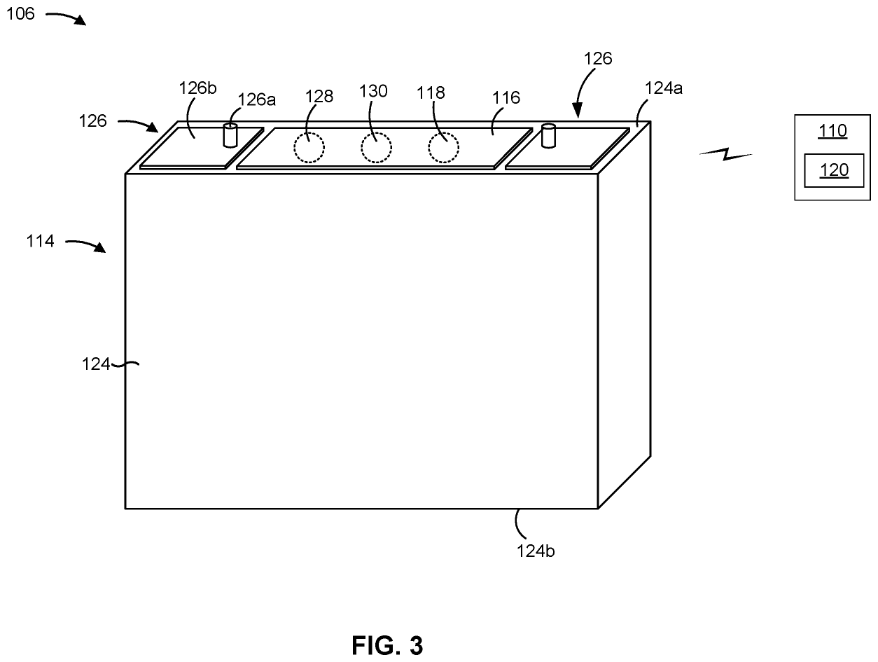

The battery pack housing 102 may include metal shielding (e.g., steel, aluminum, or the like) to protect elements (e.g., battery modules 104, battery assemblies 106, the battery pack controller 108, the module controllers 110, wires, circuit boards, or the like) positioned within battery pack housing 102. Each battery module 104 includes one or more (e.g., a plurality of) battery assemblies 106 (e.g., positioned within a module housing of the battery module 104). As shown, a battery assembly 106 includes a battery cell 114 and a thermal management device 116 (e.g., which may include a cell monitoring board, such as a cell monitoring board of the wireless battery management system marketed by Dukosi Limited), as described in connection with FIGS. 2 and 3, mounted on the battery cell 114. Battery cells 114 may be connected in series and/or in parallel within the battery module 104 (e.g., via terminal-to-busbar welds). Each battery cell 114 is associated with a chemistry type. The chemistry type may include lithium ion (Li-ion) (e.g., lithium ion polymer (Li-ion polymer), lithium iron phosphate (LFP), and/or nickel manganese cobalt (NMC)), nickel-metal hydride (NiMH), and/or nickel cadmium (NiCd), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery assemblies 106 included in each battery module 104, and the number of battery modules 104 included in the battery pack 100 (e.g., and the relative serial and/or parallel connections of the battery cells 114 and/or the battery modules 104) may be associated with the required output power and an intended use of the battery pack 100. For example, any number of battery cells 114 can be included in a battery module 104. Similarly, any number of battery modules 104 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108, as well as with the thermal management devices 116 of the battery module 104.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery cell assemblies 106. The one or more parameters may include cell voltages, temperatures, chemistry types, a cell energy throughput, a cell internal resistance, and/or a quantity of charge-discharge cycles of a battery module 104, among other examples.

The battery pack controller 108 and/or a module controller 110 includes a processor and/or memory. The processor may include a central processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. In some implementations, the processor may include one or more processors capable of being programmed to perform one or more operations or processes described elsewhere herein. The memory may include volatile and/or nonvolatile memory. For example, the memory may include random access memory (RAM), read only memory (ROM), and/or another type of memory (e.g., a flash memory, a magnetic memory, and/or an optical memory). The memory may include internal memory (e.g., RAM, ROM, or a hard disk drive) and/or removable memory (e.g., removable via a universal serial bus connection). The memory may be a non-transitory computer-readable medium. The memory may store information, one or more instructions, and/or software (e.g., one or more software applications) related to the operation of the battery pack 100, a battery module 104, and/or a battery assembly 106. The memory may include one or more memories that are coupled (e.g., communicatively coupled) to the processor, such as via a bus. Communicative coupling between a processor and a memory may enable the processor to read and/or process information stored in the memory and/or to store information in the memory.

As indicated above, FIG. 1 is provided as an example. Other examples may differ from what is described with regard to FIG. 1.

FIG. 2 is a diagram of an example battery module 104. The module controller 110 and a battery assembly 106 may be configured to wirelessly communicate with each other. For example, the module controller 110 may wirelessly communicate with a wireless communication component 118 of a thermal management device 116 of the battery assembly 106. The wireless communication component 118 includes a transceiver and/or a separate receiver and transmitter that enables the wireless communication component 118 to communicate with the module controller 110. The wireless communication component 118 may include a radio frequency (RF) interface, a wireless local area network interface, a cellular network interface, or the like. The wireless communication component 118 may include an antenna for wireless communication. In some implementations, the wireless communication component 118 is configured for near-field communication.

The module controller 110 includes a wireless communication component 120. The wireless communication component 120 includes a transceiver and/or a separate receiver and transmitter that enables the wireless communication component 120 to communicate with the thermal management device 116. The wireless communication component 120 may be similar to the wireless communication component 118, described herein. The wireless communication component 120 may include an antenna 122 for wireless communication. The antenna 122 may be a bus antenna as shown. For example, the antenna 122 may be configured in a path that passes near to each wireless communication component 118 of the battery assemblies 106, thereby facilitating near-field communication between the wireless communication component 120 and each wireless communication component 118. In some implementations, the module controller 110 and the battery assemblies 106 may wirelessly communicate using a different system and/or configuration from that described above.

As indicated above, FIG. 2 is provided as an example. Other examples may differ from what is described with regard to FIG. 2.

FIG. 3 is a diagram of an example battery assembly 106. As described herein, the battery assembly 106 includes a battery cell 114 and a thermal management device 116. The battery cell 114 may be a prismatic battery cell. For example, the battery cell 114 may include a casing 124 (e.g., a rigid outer casing) that contains an electrolyte and a set of battery layers (also referred to as a “jelly roll”). The set of battery layers may include an anode electrode layer, a cathode electrode layer, and a separator layer between the anode electrode layer and the cathode electrode layer.

The casing 124 may have a first end 124a and a second end 124b opposite the first end 124a. The battery cell 114 may include a terminal 126. For example, a set of terminals 126, including a first terminal 126 and a second terminal 126 (e.g., positive and negative terminals), may be connected at the first end 124a of the casing 124, and may define an inter-terminal space of the first end 124a between the terminals 126. Thus, the first end 124a of the casing 124 may be a top of the battery cell 114 based on an orientation used for the battery cell 114 in a battery module 104. The terminals 126 may be connectors providing points of electrical connection for an external circuit. For example, each terminal 126 may include a post 126a extending upward from the first end 124a of the casing 124, and the post 126a may extend from a pad 126b disposed on the first end 124a of the casing 124. In some implementations, the terminals 126 may use an alternative connection mechanism, such as tabs, pads, or the like. The terminals 126 may have respective electrical connections to current collectors (e.g., an anode current collector and a cathode current collector), that in turn electrically connect to the set of battery layers. In some implementations, the first end 124a of the casing 124 may include a vent (not shown) configured to release gas from the casing 124 during an overpressure event or other thermal event.

In some implementations, the terminals 126 may be connected at opposite ends of the casing 124. For example, the first terminal 126 may be connected at the first end 124a of the casing 124, and the second terminal 126 may be connected at the second end 124b of the casing 124. In this configuration, the first end 124a may include a vent, as described above, and the second end 124b may include an injection port (e.g., for delivering an electrolyte into the casing 124).

The thermal management device 116 may be mounted on the casing 124. For example, the thermal management device 116 may be mounted on the first end 124a of the casing 124. As an example, the thermal management device 116 may be mounted on the casing 124 in the inter-terminal space of the first end 124a between the first terminal 126 and the second terminal 126. The thermal management device 116 may be an integrated circuit (IC) chip, such as a field programmable gate array (FPGA) chip, an application specific integrated circuit (ASIC) chip, or the like. The thermal management device 116 may be powered by the battery cell 114 and/or by a power source external to the battery cell 114.

The thermal management device 116 may include a temperature sensor 128, a heating element 130, and/or the wireless communication component 118 described herein. In addition, the thermal management device 116 may include a voltage sensor (not shown). The voltage sensor may connect to the terminals 126 to measure a voltage of the battery cell 114. In some implementations, the thermal management device 116 may include a resistor (not shown), and the thermal management device 116 may be configured to modulate a current through the resistor to provide cell balancing for a battery module 104 (e.g., based on SoC levels of cells of the battery module 104). Alternatively, the heating element 130 may be used in place of the resistor (e.g., the heating element 130 is a resistor), and cell balancing for the battery module 104 may operate via the heating element 130. In other words, the heating element 130 may be included in a cell balancing circuit of the battery assembly 106. Thus, the heating element 130 may provide the dual functions of cell balancing for the battery cell 114 and heating of the battery cell 114. The thermal management device 116 may include a substrate, such as a circuit board (e.g., a printed circuit board), and the components of the thermal management device 116 described above may be mounted on the substrate or otherwise electrically connected to the substrate.

The temperature sensor 128 may include an IC temperature sensor, a thermistor, a thermocouple, a resistance temperature detector, or the like. The temperature sensor 128 may be in direct contact with the casing 124. The temperature sensor 128 may be configured to collect temperature data relating to a temperature of the battery cell 114 (e.g., of a body of the battery cell 114). For example, the temperature data may relate to a temperature of a surface of the casing 124. In some implementations, the temperature sensor 128, or an additional temperature sensor (not shown) of the thermal management device 116, may be configured to collect additional temperature data relating to a temperature of the thermal management device 116 (e.g., a chip temperature).

The heating element 130 may be configured to transfer heat to the battery cell 114. The heating element 130 may include one or more resistive heating elements. For example, the heating element 130 may include one or more positive temperature coefficient (PTC) heating elements. Additionally, or alternatively, the heating element 130 may include one or more resistors and/or one or more thermistors, among other examples. Integrating the heating element 130 in the thermal management device 116 uses less space on the casing 124 relative to a standalone heating system. The heating element 130 may be in direct contact with the casing 124. For example, the heating element 130 may contact the casing 124 at the inter-terminal space of the first end 124a between the first terminal 126 and the second terminal 126. This location of the heating element 130 may effectively and efficiently transfer heat to the terminals 126, and thereby to the current collectors and the set of battery layers.

In some implementations, the thermal management device 116 may include multiple heating elements 130. For example, where the battery cell 114 includes terminals 126 connected at opposite ends of the casing 124, the thermal management device 116 may include a first heating element 130 and a second heating element 130. The first heating element 130 may contact the first end 124a of the casing 124, and may be configured to transfer heat to the battery cell 114 via the first end 124a. The second heating element 130 may contact the second end 124b of the casing 124, and may be configured to transfer heat to the battery cell 114 via the second end 124b. The first heating element 130 and/or the second heating element 130 may electrically connect to the thermal management device 116 via wires, thereby allowing the first heating element 130 and/or the second heating element 130 to be located on the casing 124 remotely from a substrate of the thermal management device 116.

A module controller 110 (e.g., of a battery module 104 that includes the battery assembly 106) may be configured to wirelessly control (e.g., via a wireless connection between the wireless communication component 118 and the wireless communication component 120) the heating element 130 based on the temperature data collected by the temperature sensor 128. For example, to wirelessly control the heating element 130, the module controller 110 may receive the temperature data via a wireless connection (e.g., a wireless communication link) between the module controller 110 and the thermal management device 116, and/or the module controller 110 may transmit one or more control commands via the wireless connection. Accordingly, the wireless communication component 118 of the thermal management device 116 may be configured to wirelessly receive control commands (e.g., that are based on the temperature data) for the heating element 130.

A control command may indicate an electrical current for the heating element 130 (e.g., whether current to the heating element 130 is to be turned on or off, or a level of current to be supplied to the heating element 130). Thus, the thermal management device 116 may be configured to control the heating element 130 in accordance with the control commands. For example, the thermal management device 116 may include a driver component (not shown), such as driver circuitry electrically connected to the heating element 130, configured to control electrical current to the heating element 130 in accordance with the control commands.

The module controller 110 may be configured to monitor the temperature data, or other data or signals, to detect conditions or events for activating (i.e., turning on) or deactivating (i.e., turning off) the heating element 130. The module controller 110 may use closed-loop feedback (e.g., based on the temperature data) to control activation and deactivation of the heating element 130 as well as to control a level of electrical current supplied to the heating element 130.

As an example, to wirelessly control the heating element 130, the module controller 110 may monitor the temperature data, and detect that the temperature data indicates that a temperature of the battery cell 114 is less than or equal to an activation threshold (e.g., a cold temperature at which charging and discharging of the battery cell 114 is affected). Based on the temperature data indicating that the temperature of the battery cell is less than or equal to the activation threshold, the module controller 110 may transmit a control command, to the thermal management device 116, to activate the heating element 130 (e.g., the control command may indicate that electrical current is to be supplied to the heating element 130 and/or may indicate a level of electrical current that is to be supplied to the heating element 130).

Moreover, while continuing to monitor the temperature data after activation of the heating element 130, the module controller 110 may detect that the temperature data indicates that the temperature of the battery cell 114 is raised to (e.g., is equal to or greater than) a deactivation threshold (e.g., a temperature greater than the activation threshold). Based on the temperature data indicating that the temperature of the battery cell is raised to the deactivation threshold, the module controller 110 may transmit an additional control command to deactivate the heating element (e.g., the control command may indicate that electrical current to the heating element 130 is to be turned off or reduced to a standby level).

As another example, to wirelessly control the heating element 130, the module controller 110 may detect that the battery cell 114 is to be charged. For example, the module controller 110 may receive, from the battery pack controller 108, an indication that the battery cell 114 is to be charged (e.g., an indication that the battery pack 100 or the battery module 104 including the battery cell 114 is to be charged), and the module controller 110 may detect that the battery cell 114 is to be charged based on the indication. In some examples, the battery pack controller 108, the module controller 110, and/or another controller may detect that the battery cell 114 is to be charged based on detecting that a machine associated with the battery pack 100 has been plugged into an electrical power source. In some examples, the battery pack controller 108, the module controller 110, and/or another controller may detect that the battery cell 114 is to be charged based on a level of charge of the battery cell 114 dropping to (e.g., being less than or equal to) a charging threshold. Additionally, or alternatively, the battery pack controller 108, the module controller 110, and/or another controller may detect that the battery cell 114 is to be charged based on detecting a charging initiation event, such as braking of a vehicle associated with the battery pack 100 (e.g., regenerative braking), coasting or deceleration of the vehicle (e.g., regenerative coasting), or the like. Detection of one of the aforementioned events by the battery pack controller 108 or another controller may cause an indication, as described above, to be transmitted to the module controller 110.

Based on detecting that the battery cell 114 is to be charged (e.g., and also detecting that the temperature of the battery cell 114 is less than or equal to a threshold, which may be different from or the same as the activation threshold described herein), the module controller 110 may transmit a control command, to the thermal management device 116, to activate the heating element 130, in a similar manner as described above. Moreover, after transmitting the control command to activate the heating element 130 but prior to charging of the battery cell 114 beginning, the module controller 110 may transmit an additional control command, to the thermal management device 116, to deactivate the heating element 130. For example, the module controller 110 may detect that the temperature of the battery cell 114 is raised to (e.g., is equal to or greater than) a threshold, which may be different from or the same as the deactivation threshold described herein, and the module controller 110 may transmit the additional control command based on the temperature being raised to the threshold. Additionally, or alternatively, the module controller 110 may transmit the additional control command based on a particular amount of time elapsing from activation of the heating element 130.

In some implementations, while the heating element 130 is activated, the module controller 110 may transmit control commands to cause modulation of a thermal output of the heating element 130. For example, the control commands may indicate a modulation of the electrical current supplied to the heating element 130. As an example, to wirelessly control the heating element 130, the module controller 110 may monitor the temperature data, and the module controller 110 may transmit, to the thermal management device 116 and based on the temperature data, a control command to modulate a current to the heating element 130 (e.g., to increase or decrease a current to the heating element 130 in order to maintain a temperature of the battery cell 114 within a particular temperature range or at a temperature set point).

In one example, to wirelessly control the heating element 130, the module controller 110 may monitor the additional temperature data relating to the thermal management device 116, and the module controller 110 may detect that the additional temperature data indicates that a temperature of the thermal management device 116 satisfies (e.g., is greater than or equal to) an overheating threshold (e.g., caused by heating due to activation of the heating element 130). Based on the additional temperature data indicating that the temperature of the thermal management device 116 satisfies the overheating threshold, the module controller 110 may transmit, to the thermal management device 116, a control command to modulate a current to the heating element 130 (e.g., to decrease a current to the heating element 130).

Moreover, once the temperature of the thermal management device 116 normalizes (e.g., the temperature is less than or equal to a safe-operation threshold), the module controller 110 may transmit, to the thermal management device 116, an additional control command to modulate a current to the heating element 130 (e.g., to increase a current to the heating element 130). In this way, the module controller 110 may cause modulation of the current (e.g., using closed-loop feedback) to maximize a thermal output of the heating element 130 while avoiding overheating of the thermal management device 116. In other words, the current supplied to the heating element 130 may be modulated to maximize the thermal output of the heating element 130 while maintaining the temperature of the thermal management device 116 below an overheating level.

In some implementations, a control command to activate or to modulate the heating element 130 may be based on a mapping (e.g., a look-up table) of heating element currents to battery cell temperatures. For example, the mapping may indicate that a particular current is to be supplied to the heating element 130 to increase or decrease temperature by a particular amount or to a particular target. In some implementations, one or more operations described herein as being performed by the module controller 110 may be performed by the battery pack controller 108 (e.g., where wireless communication between the battery pack controller 108 and the thermal management device 116 is via the module controller 110).

As indicated above, FIG. 3 is provided as an example. Other examples may differ from what is described with regard to FIG. 3.

### INDUSTRIAL APPLICABILITY

The thermal management device described herein may be used with battery cells, and/or any battery module or battery pack that includes the battery cells, used to power a load or used for energy storage. For example, the thermal management device may be used with battery cells used to power an electric or hybrid vehicle or work machine, or for use in an energy storage application (e.g., associated with solar or wind power generation, or the like). In some cases, a battery may be subjected to cold temperature conditions (e.g., a work machine using the battery may operate in cold temperatures). In cold temperatures, a discharging capability and/or a charging capability of the battery may diminish, thereby impairing a performance of a machine that uses the battery.

Battery warming technologies using heating element sheets placed beneath battery cells of a battery module may result in non-uniform temperature distributions that impact battery cell performance and useful life. Furthermore, battery warming technologies using heating element sheets placed in between battery cells of a battery module may occupy excessive space in the battery module thereby reducing an energy density of the battery module. Moreover, liquid-based battery thermal management systems may have a slow response time, thereby using extra time and/or power for battery warming.

The thermal management device described herein is useful for regulating the temperature of a battery cell. In particular, the thermal management device may provide heating to the battery cell in order to warm the battery cell in cold temperature conditions and/or prior to battery charging. The thermal management device may be mounted on the same side of the battery cell as the terminals for the battery cell, thereby facilitating effective, efficient, and uniform heat transfer to interior components of the battery cell via the terminals.

Moreover, a controller may wirelessly control a thermal output of the thermal management device. Using wireless communication between the controller and the thermal management device, rather than wires and associated hardware, reduces a weight, a footprint, and a complexity of a battery module that includes the battery cell. Furthermore, using the wireless communication, rather than wires and associated hardware, improves a resiliency of the battery module to failures associated with electrical shorts, wire abrasion, and/or cable disconnection (e.g., due to vibration), among other examples.

What is claimed is:

1. A battery assembly, comprising:
a battery cell, comprising:
a casing having a first end and a second end opposite the first end; and
a terminal connected at the first end of the casing; and
a thermal management device comprising:
a heating element contacting the first end of the casing and configured to transfer heat to the battery cell;
a temperature sensor configured to collect temperature data relating to the battery cell; and
a wireless communication component configured to wirelessly receive control commands, based on the temperature data, for the heating element,
the thermal management device configured to control the heating element in accordance with the control commands.

2. The battery assembly of claim 1, wherein the thermal management device is an integrated circuit chip.

3. The battery assembly of claim 1, wherein the heating element includes a resistive heating element.

4. The battery assembly of claim 1, wherein the heating element includes a positive temperature coefficient (PTC) heating element.

5. The battery assembly of claim 1, wherein the terminal is a first terminal, and the battery cell further comprises a second terminal connected at the first end of the casing, and
wherein the thermal management device is mounted on the casing between the first terminal and the second terminal.

6. The battery assembly of claim 1, wherein the terminal is a first terminal, and the battery cell further comprises a second terminal connected at the first end of the casing, and
wherein the heating element contacts the casing between the first terminal and the second terminal.

7. The battery assembly of claim 1, wherein the terminal is a first terminal, and the battery cell further comprises a second terminal connected at the second end of the casing, and
wherein the heating element is a first heating element, and the thermal management device further comprises a second heating element contacting the second end of the casing.

8. A battery module, comprising:
a battery cell;
a thermal management device, mounted on the battery cell, comprising:
a heating element contacting the battery cell and configured to transfer heat to the battery cell; and
a temperature sensor configured to collect temperature data relating to the battery cell; and
a controller configured to wirelessly control the heating element based on the temperature data.

9. The battery module of claim 8, wherein the controller, to wirelessly control the heating element, is configured to:
receive the temperature data via a wireless connection between the controller and the thermal management device; and
transmit one or more control commands via the wireless connection.

10. The battery module of claim 8, wherein the controller, to wirelessly control the heating element, is configured to:
monitor the temperature data;
detect that the temperature data indicates that a temperature of the battery cell is less than or equal to an activation threshold; and
transmit a control command to activate the heating element based on the temperature data indicating that the temperature of the battery cell is less than or equal to the activation threshold.

11. The battery module of claim 10, wherein the controller, to wirelessly control the heating element, is configured to:
detect that the temperature data indicates that the temperature of the battery cell is raised to a deactivation threshold; and
transmit an additional control command to deactivate the heating element based on the temperature data indicating that the temperature of the battery cell is raised to the deactivation threshold.

12. The battery module of claim 8, wherein the controller, to wirelessly control the heating element, is configured to:
detect that the battery cell is to be charged; and
transmit a control command to activate the heating element based on detecting that the battery cell is to be charged.

13. The battery module of claim 12, wherein the controller, to wirelessly control the heating element, is further configured to:
transmit an additional control command to deactivate the heating element prior to charging of the battery cell.

14. The battery module of claim 8, wherein the controller, to wirelessly control the heating element, is configured to:
monitor additional temperature data relating to the thermal management device;
detect that the additional temperature data indicates that a temperature of the thermal management device satisfies an overheating threshold; and
transmit a control command to modulate a current to the heating element based on the additional temperature data indicating that the temperature of the thermal management device satisfies the overheating threshold.

15. The battery module of claim 8, wherein the thermal management device further comprises a first wireless communication component,
wherein the controller comprises a second wireless communication component, and
wherein the controller is configured to wirelessly control the heating element via a wireless connection between the first wireless communication component and the second wireless communication component.

16. A thermal management device, comprising:
a heating element configured to transfer heat to a battery cell;
a temperature sensor configured to collect temperature data relating to the battery cell; and
a wireless communication component configured to wirelessly receive control commands, that are based on the temperature data, for the heating element.

17. The thermal management device of claim 16, further comprising:
a driver component configured to control electrical current to the heating element in accordance with the control commands.

18. The thermal management device of claim 16, wherein the wireless communication component is further configured to wirelessly transmit the temperature data.

19. The thermal management device of claim 16, wherein the heating element includes a positive temperature coefficient (PTC) heating element.

20. The thermal management device of claim 16, wherein the wireless communication component is configured for near-field communication.
